(19) United States
(12) Patent Application Publication
(10) Pub. No.: US 2018/0088570 A1
(43) Pub. Date: Mar. 29, 2018

(54) METHOD FOR MONITORING THE FUNCTION OF A SENSOR ARRANGEMENT

(71) Applicant: Endress+Hauser Conducta GmbH+Co, KG, Gerlingen (DE)

(72) Inventors: Bo Ottersten, Regensburg (DE); Martin Freudenberger, Schwalkheim (DE); Kazuhiko Yamamoto, Ditzingen (DE)

(21) Appl. No.: 15/704,146

(22) Filed: Sep. 14, 2017

(30) Foreign Application Priority Data
Sep. 29, 2016 (DE) 10 2016 118 544.2

(51) Int. Cl. G05B 23/02; G01N 27/416

(52) U.S. Cl. CPC G05B 23/0283; G01N 27/4163

(57) ABSTRACT

The present disclosure relates to a method for monitoring the function of a sensor arrangement with at least two measuring points, wherein a sensor is arranged at each measuring point to determine at least one process variable of a medium, comprising the steps of contacting the medium with the sensors, determining a temporal load value for each measuring point from the at least one process variable that was determined at this measuring point, determining a total load value for each sensor from the temporal load value of the measuring point where the sensor was used and from the time during which the sensor was used at this measuring point, predicting a lifespan of a sensor at a certain measuring point based upon the temporal load value of this measuring point and the total load value of this sensor.

### CROSS-REFERENCE TO RELATED APPLICATION

The present application is related to and claims the priority benefit of German Patent Application No. 10 2016 118 544.2, filed on Sep. 29, 2016, the entire contents of which are incorporated herein by reference.

### TECHNICAL FIELD

The present disclosure relates to a method for monitoring the function of a sensor arrangement comprising several sensors for determining at least one process variable of a medium.

### BACKGROUND

In process measuring technology and process automation, electrochemical sensors are used worldwide for example, to measure the pH value, dissolved oxygen, or the specific conductivity. The prior art today consists of digital sensors with storage facilities for process and sensor data. These sensors are connected to appropriate measuring transducers during the measurement in the process.

Electrochemical sensors show aging and wear, whereby the properties slowly change. When an electrochemical sensor is calibrated and adjusted, it is usually carried out using suitable software, which reads and stores all of the data stored in the sensor. In this way, the entire life cycle of a sensor is captured and can be evaluated by the software. As long as the sensor is connected to the process, it counts and registers, for example, the time, pH value, temperature, and/or other process parameters. The data captured in this way can be used for predictive maintenance, and thus also to predict whether the sensor is still usable for the time required in the future.

The load data stored by the sensor are only captured in an integrated manner for the total load. If a sensor is always used at the same measuring point again, these data are sufficient for the prediction.

In practice, however, several sensors from a sensor pool are often used, which sensors are used at different measuring points at a fixed maintenance interval. In the process, the user takes, for example, ten adjusted sensors from a sensor pool in the laboratory and exchanges them at ten different measuring points, without paying attention to the measuring point where the sensor was previously used. In doing so, the process data and thus the sensor stress data can vary greatly from use to use, which makes a prediction of the usability in the future more difficult, or even impossible. In extreme cases, pH sensors with different reference systems may even be used, which then even differ from one another depending upon the process use.

### SUMMARY

The present disclosure is based upon the aim of providing a method for monitoring a potentiometric sensor, which method correctly determines the service life or the remaining lifespan of the sensor under fluctuating process conditions.

The aim is achieved by the subject matter of the present disclosure. The subject matter of the present disclosure is a method for monitoring the function of a sensor arrangement with at least two measuring points (A, B, C . . . ), wherein a sensor (1, 2, 3 . . . ) is arranged at each measuring point (A, B, C . . . ) to determine at least one process variable of a medium, comprising the steps: contacting the medium with the sensors, putting into operation the sensor arrangement so that the sensors determine the at least one process variable of the medium, determining a temporal load value (B/t) for each measuring point from the at least one process variable that was determined at this measuring point, determining a total load value (GB) for each sensor from the temporal load value (B/t) of the measuring point where the sensor was used and, from the time during which the sensor was used at this measuring point, predicting a lifespan of a sensor at a certain measuring point based upon the temporal load value (B/t) of this measuring point and the total load value (GB) of this sensor.

### DETAILED DESCRIPTION

The remaining lifespan of the sensors is used up at different measuring points at varying rates. The measuring point-specific remaining lifespan results therefrom and from the total load value. All sensors are connected to a central computing unit, on which laboratory software is installed. The sensors transmit not only the total load values, but also the identities of the measuring points from the measuring transducer and the last loads (pH value, temperature, time) of the respective measuring point to the computing unit, where they can be stored and processed by the laboratory software. The laboratory software thus captures not only the total load, but also the average load for each measuring point and the sensor type used there. As a result, the laboratory software is able to optimally predict sensors up to the end of the sensor lifespan, depending upon the previous load and the planned measuring point in the process.

According to a further development, a change in the calibration values and/or the adjustment values of the sensors can be considered an indication of a change in the total load values (GB) of the sensors. Changes in typical sensor properties, such as the slope and zero point, are also captured during the adjustment. In this way, the software is able to predict an average sensor lifespan for each sensor type and for each possible measuring point and, in doing so, also includes the previous total load in the calculation. Depending upon these data, the laboratory software can, for example, give the following recommendations after a calibration and adjustment have taken place in the laboratory:
Sensors 1, 3, 4, and 9 can be used without restriction at all possible measuring points until the next maintenance.
Sensors 2, 5, and 6 can be used only at the measuring points A, C, D, and F without restriction. At all other measuring points, a sensor failure is to be expected by the next maintenance.
Sensors 7, 8, and 10 are at the end of the sensor lifespan and can no longer be used reliably at any measuring point until the next maintenance.

According to a variant, the at least one process variable is the pH value and/or the temperature.

According to an embodiment, the total load value (GB) of a sensor is determined by multiplying the temporal load value (B/t) of the measuring point where the sensor was used with the time t during which the sensor was used at this measuring point:

$$GB = ( \frac{B}{t} ) \cdot t$$

If the sensor was previously operated at several measuring points A, B . . . , the total load value (GB) is determined by adding up the individual temporal load values (B/t)_{A,B} multiplied by the time t_{A,B} during which the sensor was used at this measuring point:

$$GB = {( \frac{B}{t} )}_{A} \cdot {t}_{A} + {( \frac{B}{t} )}_{B} \cdot {t}_{B} + …$$

According to an advantageous embodiment, the remaining lifespan T of a sensor at a certain measuring point is determined as follows:

$$T = \frac{{GB}_{max} - GB}{( \frac{B}{t} )}$$

wherein GBₘₐₓ is the maximum total load of a sensor, from which the sensor is no longer considered to be functional.

According to a further development, the prediction of the lifespan of a sensor at all measuring points is carried out based upon the temporal load value (B/t) of the respective measuring points and the total load value (GB) of this sensor.

In the calculation of the remaining lifespan, it is assumed that a sensor has a maximum total load value of, for example, 10,000 stress points, and, depending upon the load, the process-specific load values are deducted hourly in the form of stress points from the maximum total load value. In doing so, the sensor stores the measuring point where it was subjected to the load.

In a chemical process, for example, in which educts are measured (e.g., strong acids and strong bases) and the neutralized end product (e.g., at 70° C.), the sensors are exchanged in the system every 3 days. In doing so, the sensors from the process are cleaned, calibrated, adjusted, and stored in the laboratory. After three days, the procedure begins again.

Examples of the calculation of the stress points of a sensor after three days:

Sensor 1 in an acid (pH value=1): 32 stress points×24 h×3 days=2,304 stress points

Sensor 2 in a base (pH value=13): 48 stress points×24 h×3 days=3,456 stress points

Sensor 3 in a neutral end product (pH value=7): 8 stress points×24 h×3 days=576 stress points.

Eventually, the sensor has a load value of only 1,800 stress points, for example. Then, during calibration and adjustment in the laboratory, the user receives the information that he may no longer use this sensor at a measuring point in an acid or in a base, but may still use it reliably at a measuring point in the end product for three intervals until the next maintenance.

It is thus possible for the user to discern which sensor can be used at which measuring point. In this way, the user can make optimal use of the sensors. This saves costs and at the same time ensures that the sensor is usable (ready for the next batch) until the next maintenance.

There are processes in which the slope of a pH sensor may not fall below a minimum value. For example, the minimum value in industrial wastewater is 53 mV/pH, and in an acid and in a base, 55 mV/pH.

The user can, however, still use a sensor that can no longer be used in such processes in “easier” processes, up until the end of the lifespan of the sensor.

Table 1 lists examples of temporal load values. The load values may, however, vary depending upon the sensor type.

TABLE 1

| Temperature | pH value < 2 | pH value 2-5 | pH value 5-9 | pH value 9-12 | pH value > 12 |
|---|---|---|---|---|---|
| <10° C. | 4 | 2 | 1 | 3 | 6 |
| 10-40° C. | 8 | 4 | 2 | 6 | 12 |
| 40-60° C. | 16 | 8 | 4 | 12 | 24 |
| 60-80° C. | 32 | 16 | 8 | 24 | 48 |
| >80° C. | 60 | 30 | 15 | 45 | 90 |

Claimed is:

1. A method for monitoring the function of a sensor arrangement with at least two measuring points, comprising the steps:
contacting a medium with a sensor of the sensor arrangement, wherein the sensor arrangement includes a sensor arranged at each measuring point to determine at least one process variable of the medium;
operating the sensor arrangement such that the sensor determines the at least one process variable of the medium;
determining a temporal load value for each measuring point from the at least one process variable that was determined at this measuring point;
determining a total load value for the sensor from the temporal load value of the measuring point where the sensor was used and from a period during which the sensor was used at this measuring point; and
predicting a remaining lifespan of the sensor at a certain measuring point based upon the temporal load value of the certain measuring point and the total load value of the sensor.

2. The method according to claim 1, wherein a change in the calibration values and/or the adjustment values of the sensors is an indication of a change in the total load values of the sensors.

3. The method of claim 1, wherein the at least one process variable is the pH value and/or the temperature.

4. The method of claim 1, wherein the total load value of the sensor is determined by multiplying the temporal load value of the measuring point where the sensor was used by the period during which the sensor was used at the measuring point, as in:
$$GB = ( \frac{B}{t} ) \cdot t$$
wherein GB is the total load value of the sensor, B/t is the temporal load value of the measuring point where the sensor was used, and t is the period.

5. The method of claim 4, wherein the remaining lifespan (T) of the sensor at the certain measuring point is determined as follows:
$$T = \frac{{GB}_{max} - GB}{( \frac{B}{t} )}$$
wherein T is the remaining lifespan, and GBₘₐₓ is the maximum total load of the sensor, at which the sensor is no longer functional.

6. The method of claim 1, wherein the prediction of the remaining lifespan of the sensor at all measuring points is carried out based upon the temporal load value of the respective measuring points and the total load value of the sensor.
